(19) United States
(12) Patent Application Publication
(10) Pub. No.: US 2007/0055731 A1
(43) Pub. Date: Mar. 8, 2007

(54) SYSTEM AND METHOD FOR SECURE COMMUNICATIONS UTILIZING REALLY SIMPLE SYNDICATION PROTOCOL

(76) Inventor: Jason Thibeault, Chandler, AZ (US)

Correspondence Address: ZARETSKY & ASSOCIATES PC, 8753 W. RUNION DR., PEORIA, AZ, 85382-6412, US

(21) Appl. No.: 11/470,746

(22) Filed: Sep. 7, 2006

Related U.S. Application Data
(60) Provisional application No. 60/715,332, filed on Sep. 7, 2005.

(51) Int. Cl. G06F 15/16

(52) U.S. Cl. 709/204

(57) ABSTRACT

A novel system and method for providing secure communication between two or more users via a really simply syndication (RSS) document feed through a conventional email client. Users exchange messages via RSS documents in lieu of sending email messages using conventional email applications with the problem of spam, security and network bandwidth that typically plague conventional email systems. A unique RSS document feed exchange is established using conventional email. Once established, however, all messages in the communications session are transmitted between users using RSS documents. Users can create, edit and delete message threads on their standard web browsers or use a specialized RSS reader. The communication event messages may also be encrypted using any suitable well known encryption technique to foil malicious interception and eavesdropping.

### REFERENCE TO PRIORITY APPLICATION

This application claims priority under 35 U.S.C. §119(e) to U.S. Provisional Application Ser. No. 60/715,332, filed Sep. 7, 2006, entitled “System and Method for Secure Communications Utilizing an RSS Feed Through an Email Client,” incorporated herein by reference in its entirety.

### FIELD OF THE INVENTION

The present invention relates to the field of data communications and more particularly relates to a system and method for secure communications over one or more communication networks between a master user and one or more participant users using Really Simple Syndication (RSS) protocol.

### BACKGROUND OF THE INVENTION

In recent years the number of computers in use is increasing at an ever quickening pace. Along with the huge increase in the number of computers in use around the world, is a parallel increase in the number of computers connected to the Internet. Further, the world is witnessing an explosion of wireless devices that have the capability of connecting to the Internet as well. Such wireless devices include, for example, laptop computers, notebooks, palmtops, PDAs, cellular telephones with email and web browsing capabilities and other mobile wireless devices.

The Really Simple Syndication (RSS) format is widely used today to represent documents for delivery to a target or client computing device. It is commonly used by news organizations to distribute news feeds to a large number of subscribers or ‘bloggers’ to provide a mechanism for their readers to receive timely updates without having to frequently visit the blog site itself. Rather than requiring users to click on individual items at a news website, users subscribe to an RSS news feed. Once subscribed, users are automatically sent a copy of the news item when it is published by the news server.

Every object that can be identified through a Uniform Resource Identifier (URI) or Uniform Resource Locator (URL) is a resource that can be embedded in an RSS document. An RSS document contains information about which information objects are to be found under a URI. In addition, it can include a description of the resource and the individual information objects, the specification of a unique identifier for the objects and other information.

The number of mobile handsets and mobile devices in use within the general population has exploded in recent years. Moreover, the proliferation of mobile handsets and devices within the enterprise has matched the growth within the general population. As a consequence, enterprises are beginning to invest considerable resources in mobile applications that allow direct communication between the mobile devices and servers and desktop computers. This has enabled a growing workforce that is capable of conducting business while away from the desk, office, and most importantly, the desktop computer.

Over the past several years, email users (whether mobile or desktop) have been plagued with three significant issues that are becoming more and more of a problem for users. The first and probably both the most prolific and the most annoying is unsolicited messaging. Email users are constantly bombarded with messages that originate from senders with whom the user is unfamiliar. These messages called “spam” often have unwanted advertisements that can range in content from benign to extremely offensive. In an effort to prevent this spam, Internet Service Providers (ISPs), commercial software providers and enterprise software providers have all implemented spam “filters” which attempt to block these unwanted emails from ever getting to a user's inbox. Unfortunately, these spam filters are perfect and not all unwanted spam messages are blocked. Moreover, sometimes legitimate email messages get caught in these filters and are prevented from reaching their intended destination. On average, almost 22% of messages that are legitimate get caught in these filters and a significant percentage of “opt-in” messages get caught as well. In light of this, many ISPs offer an option of sending a list of the email messages blocked by the spam filter with the capability of a user to “unblock” any messages that was actually legitimate.

The second email issue of concern to users is security. By its nature, email is inherently insecure. Through various software techniques, a person with malicious intent can capture, intercept or eavesdrop on email data en route from its source to its destination. Email can be intercepted either during sending, receiving or anywhere along the route taken to its destination either at the client level, the server level or in web-based email programs. This is a growing problem for email users as email use grows to convey more and more information from one place to another. As part of the information flow, it is likely that the number of sensitive email messages users would prefer to remain confidential will grow as well. In addition, with the steady increase in email traffic, it is likely that the number of malicious individuals or groups attempting to intercept email traffic will grow as well.

The third and final issue of concern to email users is the limited network bandwidth available. As more and more people utilize email to communicate with each other, send videos, send pictures, etc., the sheer volume of email traffic places an increasingly larger burden on network bandwidth. The problem of email spam described hereinabove only exacerbates the problem as a significant portion of network bandwidth is consumed by unwanted spam emails.

Various prior art attempts have been made in the past to stop unsolicited email, improve email security and reduce bandwidth including attempts made by Internet Service Providers (i.e., AOL, Earthlink, etc.) and software companies (Microsoft, ISS, Symantec, McAfee, etc.). These prior art techniques have all simply built technologies meant to provide “stop-gap” patch solutions to the perceived issues and do not address the underlying problem.

There is thus a need for a mechanism that overcomes the disadvantages of the prior art. In particular, there is a need for a mechanism that is capable of providing secure communications between two or more users that is able to eliminate spam, provide security and that consumes minimal network bandwidth. It is also desirable that the implementation of the solution to this problem integrate with existing communication technology applications such as conventional existing email clients (e.g., Microsoft Outlook, Mozilla Thunderbird, etc.).

### SUMMARY OF THE INVENTION

The present invention is a system and method that permits two or more users to securely communicate with each other via a really simply syndication (RSS) feed through either a web-browser or an application that mimics a conventional email client. Using the mechanism of the present invention, users exchange messages via RSS documents. This is in lieu of sending email messages using conventional email applications with the concomitant issues and problems such as spam, security and network bandwidth discussed supra.

The secure communications mechanism of the present invention overcomes and resolves these issues by utilizing a secured means of communication between two or more persons through RSS feeds. When a user wishes to communicate with another user (either singly or multiple times), they create a unique RSS document feed exchange mechanism using the mechanism of the present invention (whether embodied in a stand-alone, email client-like application or through a standard web-browser) to which other users “subscribe” in a traditional RSS subscription methodology. Once the RSS document feed mechanism is set up, rather than “sending” (i.e. “emailing”) messages back and forth, users simply “update” a master RSS document which is refreshed by users' web browser software or stand-alone client application capable of interacting with such an RSS mechanism.

In operation, a master user sends email invitations to one or more mobile or non-mobile participant users located anywhere on the network to join a secure communications session. The email invitation is received at each participant user by a conventional email client and contains a hyperlink to the web server of the master user. Participant users that want to join the communications session click on the hyperlink and login into the communications session.

The master user authenticates each participant user and once authenticated, serves the initial message thereto. Participant users can reply to the existing message thread or begin a new message thread within the communication. Any messages from the participant users to the master user are termed a “communication event.” All communication events received at the master user are stored in participant user RSS documents. Each participant user RSS document is used to store communication events from a single participant user.

Once stored, the communication event is copied from the individual participant user RSS document to a master communication thread RSS document. This master communication thread RSS document is the document that is served (i.e. distributed) to all participant users in the communications session. The participant user RSS documents are not served to the participant users. As such, all participant users interact with a “synchronized” RSS document that comprises multiple elements from individual participant user RSS documents.

The invention also provides participant users the ability to create, edit and delete messages in a communications thread they have subscribed to. Further, the communication event messages may be encrypted using any suitable well known encryption technique to foil malicious interception and eavesdropping.

Note that some aspects of the invention described herein may be constructed as software objects that are executed in embedded devices as firmware, software objects that are executed as part of a software application on either an embedded or non-embedded computer system such as a central processing unit (CPU), digital signal processor (DSP), microcomputer, minicomputer, microprocessor, etc. running a real-time operating system such as WinCE, Symbian, OSE, Embedded LINUX, etc. or non-real time operating system such as Windows, UNIX, LINUX, etc., or as soft core realized HDL circuits embodied in an Application Specific Integrated Circuit (ASIC) or Field Programmable Gate Array (FPGA), or as functionally equivalent discrete hardware components.

There is thus provided in accordance with the invention, a method of secure communications between a master user and one or more participant users, the method comprising the steps of generating an authentication key for each participant user, sending an email invitation from the master user to each the participant user, the email invitation incorporating a hyperlink encrypted using a participant user's authentication key corresponding thereto, authenticating one or more participant users, serving a master communications thread really simple syndication (RSS) document to each successfully authenticated participant user, storing communication events received from participant users in separate participant user RSS documents and aggregating the contents of all participant user RSS documents into the master communications thread RSS document.

There is also provided in accordance with the invention, a computer program product comprising a computer usable medium having computer usable program code for secure communications between a master user and one or more participant users, the computer program product including, computer usable program code for generating an authentication key for each participant user, computer usable program code for sending an email invitation from the master user to each the participant user, the email invitation incorporating a hyperlink encrypted using a participant user's authentication key corresponding thereto, computer usable program code for authenticating one or more participant users, computer usable program code for serving a master communications thread really simple syndication (RSS) document to each successfully authenticated participant user, computer usable program code for storing communication events received from participant users in separate participant user RSS documents and computer usable program code for aggregating the contents of all participant user RSS documents into the master communications thread RSS document.

There is further provided in accordance with the invention, an apparatus for secure communications between a master user and one or more participant users via one or more communication networks comprising a master thread database adapted to store one or more master communication thread really simple syndication (RSS) documents and information related thereto, a participant database adapted to store one or more participant user RSS documents and information related thereto, an encryption unit adapted to generate an authentication key for each participant user and to encrypt and decrypt RSS document communications between the master user and the one or more participant users, a participant subscription management unit operative to send an email invitation to each participant user, the email invitation incorporating a hyperlink encrypted using a participant user's authentication key corresponding thereto, an authentication unit operative to authenticating one or more participant users, an RSS document generator comprising means for storing communication events received from successfully authenticated participant users in separate participant user RSS documents and means for aggregating the contents of all participant user RSS documents associated with a communications session into a single master communications thread RSS document.

There is also provided in accordance with the invention, a method of secure communications between a master user and one or more participant users via one or more communication networks, the method comprising the steps of receiving an email invitation from a master user to join a communications session, replying to the email invitation with participant user login credentials; and if the participant user login authentication was successful, sending communication event messages to the master user whereby the communication event messages are appended to a separate participant user really simple syndication (RSS) document and displaying to the participant user a master communications thread RSS document received from the master user that represents an aggregation of all participant user RSS documents.

There is further provided in accordance with the invention, a computer program product comprising a computer usable medium having computer usable program code for secure communications between a master user and one or more participant users via one or more communication networks, the computer program product including, computer usable program code for receiving an email invitation from a master user to join a communications session, computer usable program code for replying to the email invitation with participant user login credentials; and if the participant user login authentication was successful, computer usable program code for sending communication event messages to the master user whereby the communication event messages are appended to a separate participant user really simple syndication (RSS) document and computer usable program code for displaying to the participant user a master communications thread RSS document received from the master user that represents an aggregation of all participant user RSS documents.

There is also provided in accordance with the invention, a method of secure communications between a master user and one or more participant users, the method comprising the steps of sending an email invitation from the master user to each the participant user requesting participation in a communications session, authenticating one or more participant users utilizing login credentials provided by each respective participant user, receiving communication events from one or more participant users and storing all communication events associated with each participant user in a separate participant user really simple syndication (RSS) document and copying the communication event into a master communication thread RSS document for serving to all the participant users.

### BRIEF DESCRIPTION OF THE DRAWINGS

The invention is herein described, by way of example only, with reference to the accompanying drawings, wherein:

FIG. 1 is a block diagram illustrating an example secure communications system incorporating a master user, a plurality of mobile and non-mobile participant users and an optional secure communications server;

FIG. 2 is a block diagram illustrating an example computer processing system architecture suitable for use with the present invention.

FIG. 3 is a block diagram illustrating an example mobile device or PDA system architecture suitable for use with the present invention.

FIG. 4 is a block diagram illustrating the secure communications server of the present invention in more detail;

FIG. 5 is a block diagram illustrating the participant user computer of the present invention in more detail;

FIG. 6 is a block diagram illustrating the master user PC of the present invention in more detail;

FIGS. 7A and 7B are flow diagrams illustrating the method of starting a new communications session;

FIGS. 8A and 8B are flow diagrams illustrating the invitation acceptance and participant authentication method of the present invention;

FIG. 9 is a flow diagram illustrating the participant communication thread RSS feeds aggregation method of the present invention;

FIG. 10 is a diagram illustrating an example application of the participant communication thread RSS feeds aggregation method of FIG. 9;

FIGS. 11A and 11B are flow diagrams illustrating the secure communications method of the present invention;

FIG. 12 is a flow diagram illustrating the send message method of the present invention; and

FIG. 13 is a GUI screen shot of an example implementation of the RSS based secure communications application of the present invention.

### DETAILED DESCRIPTION OF THE INVENTION

### Notation Used Throughout

The following notation is used throughout this document.

| Term | Definition |
|---|---|
| AC | Alternating Current |
| API | Application Programming Interface |
| ASIC | Application Specific Integrated Circuit |
| ASP | Active Server Pages |
| CD-ROM | Compact Disc-Read Only Memory |
| CPU | Central Processing Unit |
| DC | Direct Current |
| DSP | Digital Signal Processor |
| EDI | Electronic Data Interchange |
| EEROM | Electrically Erasable Read Only Memory |
| EPROM | Erasable Programmable Read Only Memory |
| FM | Frequency Modulation |
| FPGA | Field Programmable Gate Array |
| FTP | File Transfer Protocol |
| GPS | Global Positioning System |
| GUI | Graphical User Interface |
| HDD | Hard Disk Drive |
| HDL | Hardware Description Language |
| HTML | Hypertext Markup Language |
| HTTP | Hypertext Transfer Protocol |
| HTTPS | SSL secured HTTP |
| I/F | Interface |
| ID | Identification |
| IM | Internet Messaging |
| IP | Internet Protocol |
| ISP | Internet Service Provider |
| LAN | Local Area Network |
| MAC | Media Access Control |
| MC | Mobile Client |
| MD5 | Message-Digest algorithm 5 |
| NIC | Network Interface Card |
| PC | Personal Computer |
| PDA | Personal Digital Assistant |
| PHP | Hypertext Preprocessor |
| PIM | Personal Information Manager |
| POP | Post Office Protocol |
| RAM | Random Access Memory |
| RF | Radio Frequency |
| ROM | Read Only Memory |
| RSA | Rivest Shamir Adleman encryption algorithm |
| RSS | Really Simple Syndication |
| SCA | Secure Communications Application |
| SIM | Subscriber Identity Module |
| SMS | Short Message Service |
| SSL | Secure Sockets Layer |
| TV | Television |
| URI | Uniform Resource Identifier |
| URL | Uniform Resource Locator |
| USB | Universal Serial Bus |
| UWB | Ultra Wideband |
| WAN | Wide Area Network. |
| WAP | Wireless Application Protocol |
| WiMAX | Worldwide Interoperability for Microwave Access |
| WLAN | Wireless Local Area Network |
| WWAN | Wireless Wide Area Network |
| XHTML | Extensible HyperText Markup Language |
| XML | Extensible Markup Language |
| XSTL | eXtensible Style Sheet Language Transformation |

### Secure Communications Mechanism

The present invention is a system and method for providing two or more users secure communications using really simply syndication (RSS) document feeds. The mechanism of the invention uses a conventional email client to initiate the secure communications session. Once initiated, RSS document feeds are used to convey the message traffic amongst all the communication session users. Using the mechanism of the present invention, users exchange messages via RSS documents, rather than send email messages back and forth using conventional email applications with the concomitant issues and problems of the prior art including unwanted spam, security risks and network bandwidth limitations, discussed supra.

The secure communications mechanism of the present invention overcomes and resolves these issues by utilizing a secured means of communication between two or more persons through RSS feeds. When a user wishes to communicate with another user (either singly or multiple times), they create a unique RSS document feed exchange mechanism using their conventional “email” application to which users “subscribe” via their individual conventional email client. Once the RSS document feed mechanism is set up, rather than “sending” (i.e. “emailing”) messages back and forth, users simply “update” a master RSS document which is refreshed by users' web browser software or application designed to render and display RSS feeds.

In operation, a master user sends email invitations to one or more mobile or non-mobile participant users located anywhere on the network to join a secure communications session. The email invitation is received at each participant user by a conventional email client and contains a hyperlink to the web server of the master user. Participant users that want to join the communications session click on the hyperlink and login into the communications session.

The master user authenticates each participant user and once authenticated, serves the current contents of the master RSS document. Participant users can reply to an existing message thread or begin a new message thread within the communication session. Any communications from the participant users to the master user is termed a “communication event.” All communication events received at the master user are stored in participant user RSS documents. Each participant user RSS document is used to store communication events from a single participant user.

Once stored, the communication event is copied from the individual participant user RSS document to a master communication thread RSS document. This master communication thread RSS document is the document that is served (i.e. distributed) to all participant users in the communications session. The participant user RSS documents are not served to the participant users.

The invention also provides participant users the ability to create, edit and delete messages in a communications thread to which they have subscribed. Further, the communication event messages may be encrypted using any suitable well known encryption technique to foil malicious interception and eavesdropping.

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be born in mind that all of the above and similar terms are to be associated with the appropriate physical quantities they represent and are merely convenient labels applied to these quantities. Unless specifically stated otherwise as apparent from the following discussions, it is appreciated that throughout the present invention, discussions utilizing terms such as ‘processing,’ ‘computing,’ ‘calculating,’ ‘determining,’ ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention can take the form of an entirely hardware embodiment, an entirely software embodiment or an embodiment containing a combination of hardware and software elements. In a preferred embodiment, the invention is implemented in software, which includes but is not limited to firmware, resident software, object code, assembly code, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium is any apparatus that can contain, store, communicate, propagate, or transport the program for use by or in connection with the instruction execution system, apparatus, or device, e.g., floppy disks, removable hard drives, computer files comprising source code or object code, flash semiconductor memory (USB flash drives, etc.), ROM, EPROM, or other semiconductor memory devices.

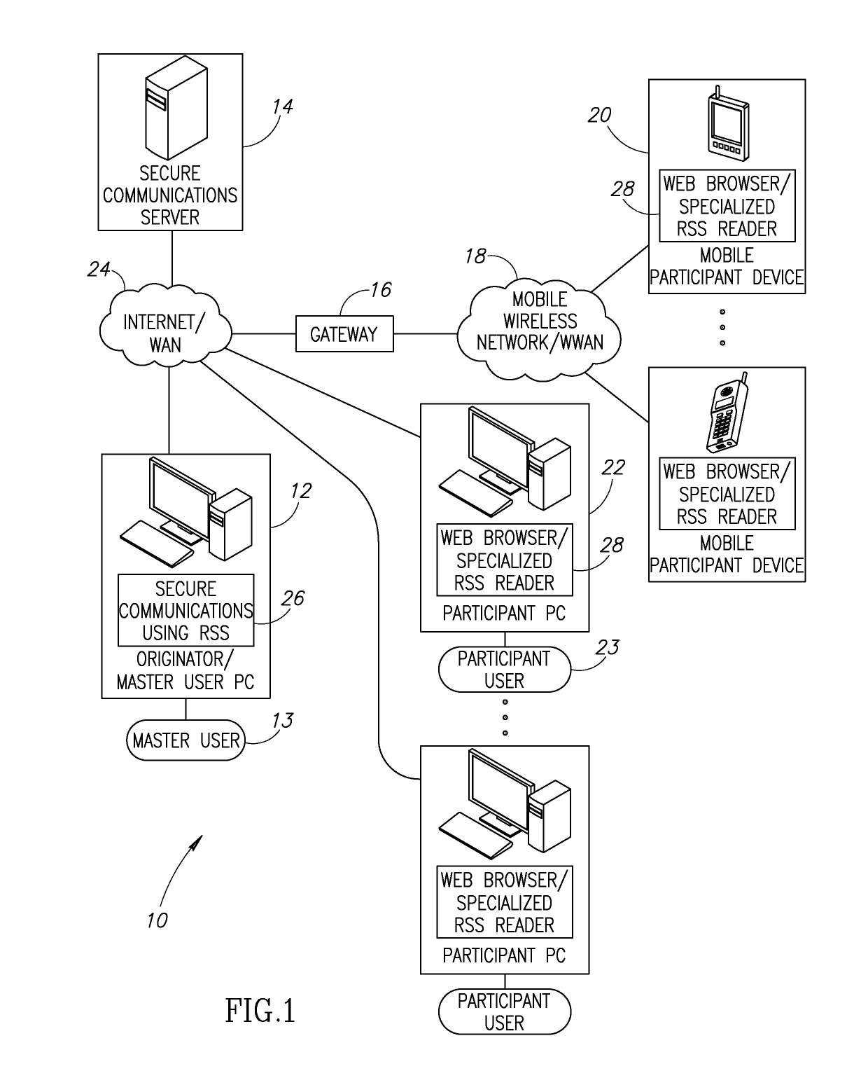

A block diagram illustrating an example secure communications system incorporating a master user, a plurality of mobile and non-mobile participant users and an optional secure communications server is shown in FIG. 1. The example system, generally referenced 10, comprises an Internet/WAN/WWAN cloud 24, a plurality of mobile participant users 21 connected to mobile participant devices 20 (e.g., PDAs, cellular phones, etc.) adapted to run a standard web browser or specialized RSS reader of the present invention 28, a plurality of non-mobile participant users 23 connected to participant user PCs 22 adapted to run a standard web browser or specialized RSS reader of the present invention 28, an optional secure communications server 14, gateway 16, mobile wireless network 18, e.g., Wireless Wide Area Network (WWAN) and an originator or master user 13 connected to a master user PC 12 adapted to implement the secure communications application 26 of the present invention. A PC user 28 is connected to and interacts with the send document agent application.

Note that the master user PCs, participant user PCs, secure communications server, mobile participant device may comprise any type of computing device such as PC, laptop, notebook, palmtop, PDA, microcomputer, minicomputer, wired or wireless device, etc. without departing from the scope of the invention. Further, the participant mobile device may comprise any computing device with the ability to connect to a mobile wireless network, e.g., PDA, Blackberry type device, Treo type device, etc. Internet access to the mobile devices is provided via the gateway 16 which connects the mobile wireless network 18 to the Internet cloud 24. The master user PC, participant user PCs, mobile participant devices and secure communications server may reside anywhere in the network.

The master user is defined as the originator of the communications thread (or session). The participant users are defined as all other users other than the master user that are to participate in the communications thread. The secure communications using RSS application 26 of the present invention is adapted to run on the master user PC. The application 26 may be constructed as software, hardware or a combination or hardware or software. It is noted that the invention does not require special software on the participant user PC or mobile device. Only a standard conventional web browser is needed in order to implement the mechanism of the present invention. The participant user mobile device can comprise any type of processing device such as a desktop PC, laptop PC, notebook, palmtop, PDA, cellular telephone with web access, etc., and is not critical to the operation of the invention.

The participant user PC or mobile device may be construed as any software, hardware or combination of software and hardware, capable of communicating with the master user PC which includes, but is not limited to, a conventional web browser or any other well known and widely available software application that can access HTML and render RSS documents to the end user. Note that throughout this document, references to the term “participant users” are intended to refer to participant PC users and participant mobile device users. References to the term “participant user computers” are intended to refer to participant user PCs and mobile participant devices.

Alternatively, a specialized RSS reader application can be used on the participant user PC or mobile device to render the RSS documents and provide additional functions as described in more detail infra. This specialized RSS reader application is optional and is not a requirement of the present invention.

Note that in this example, the manner of how the mobile participant user communicates with the master user PC is not critical to the invention. For illustrative purposes only, the mobile participant user may use a wireless PDA or a cellular telephone wherein each connects to the Internet through the wireless network 18. The master user PC is shown connected directly to the Internet. It is appreciated, however, that a master user PC may comprise a laptop computer equipped with a wireless communications card which is capable of communicating over the wireless network 18 as well.

### Computer Processing System

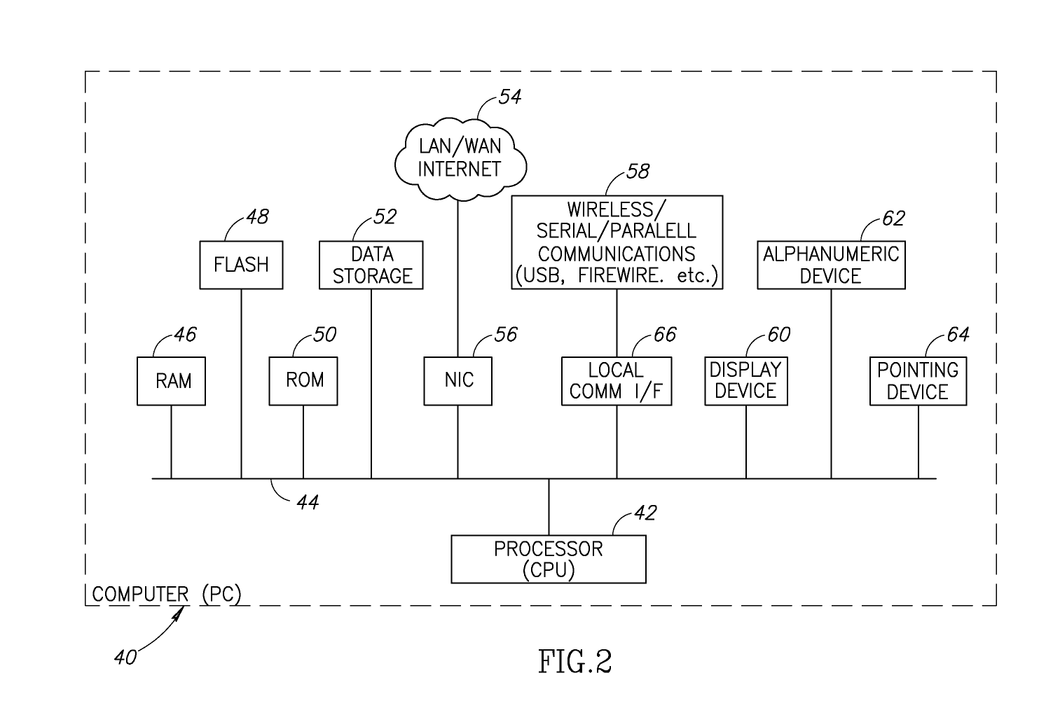

A block diagram illustrating an example computer processing system architecture suitable for use with the present invention is shown in FIG. 2. The computer system, generally referenced 40, comprises a processor 42 which may comprise a digital signal processor (DSP), central processing unit (CPU), microcontroller, microprocessor, microcomputer, ASIC or FPGA core. The system also comprises static read only memory 50 and dynamic main memory 46 all in communication with the processor. The processor is also in communication, via bus 44, with a number of peripheral devices that are also included in the computer system. Peripheral devices coupled to the bus include a display device 60 (e.g., monitor), alpha-numeric input device 62 (e.g., keyboard) and pointing device 64 (e.g., mouse, tablet, etc.)

The computer system is connected to one or more external networks such as a LAN or WAN 54 via communication lines connected to the system via a network interface card (NIC). A local communications I/F port(s) 66 provides connections to various wireless and wired links and serial and parallel devices. Examples include peripherals (e.g., printers, scanners, etc.), wireless links (e.g., Bluetooth, UWB, WiMedia, WiMAX, etc.) and wired links (e.g., USB, Firewire, etc.) The network adapters 56 and local communications I/F port(s) 66 coupled to the system enable the data processing system to become coupled to other data processing systems or remote printers or storage devices through intervening private or public networks. Modems, cable modem and Ethernet cards are just a few of the currently available types of network adapters.

The system also comprises magnetic or semiconductor based storage device 52 (e.g., RAM) for storing application programs and data. The system comprises computer readable storage medium that may include any suitable memory means, including but not limited to, magnetic storage, optical storage, semiconductor volatile or non-volatile memory, biological memory devices, or any other memory storage device.

Software adapted to implement the secure communications mechanism of the present invention is adapted to reside on a computer readable medium, such as a magnetic disk within a disk drive unit. Alternatively, the computer readable medium may comprise a floppy disk, removable hard disk, Flash memory 46, EEROM based memory, bubble memory storage, ROM storage, distribution media, intermediate storage media, execution memory of a computer, and any other medium or device capable of storing for later reading by a computer a computer program implementing the system and methods of this invention. The software adapted to implement the secure communications mechanism of the present invention may also reside, in whole or in part, in the static or dynamic main memories or in firmware within the processor of the computer system (i.e. within microcontroller, microprocessor or microcomputer internal memory).

Other digital computer system configurations can also be employed to implement the secure communications mechanism of the present invention, and to the extent that a particular system configuration is capable of implementing the system and methods of this invention, it is equivalent to the representative digital computer system of FIG. 2 and within the spirit and scope of this invention.

Once they are programmed to perform particular functions pursuant to instructions from program software that implements the system and methods of this invention, such digital computer systems in effect become special purpose computers particular to the method of this invention. The techniques necessary for this are well-known to those skilled in the art of computer systems.

It is noted that computer programs implementing the system and methods of this invention will commonly be distributed to users on a distribution medium such as floppy disk, semiconductor memory (USB flash, etc.) or CD-ROM or may be downloaded over a network such as the Internet using FTP, HTTP, or other suitable protocols. From there, they will often be copied to a hard disk or a similar intermediate storage medium. When the programs are to be run, they will be loaded either from their distribution medium or their intermediate storage medium into the execution memory of the computer, configuring the computer to act in accordance with the method of this invention. All these operations are well-known to those skilled in the art of computer systems.

### Mobile Device/Cellular Phone/PDA System

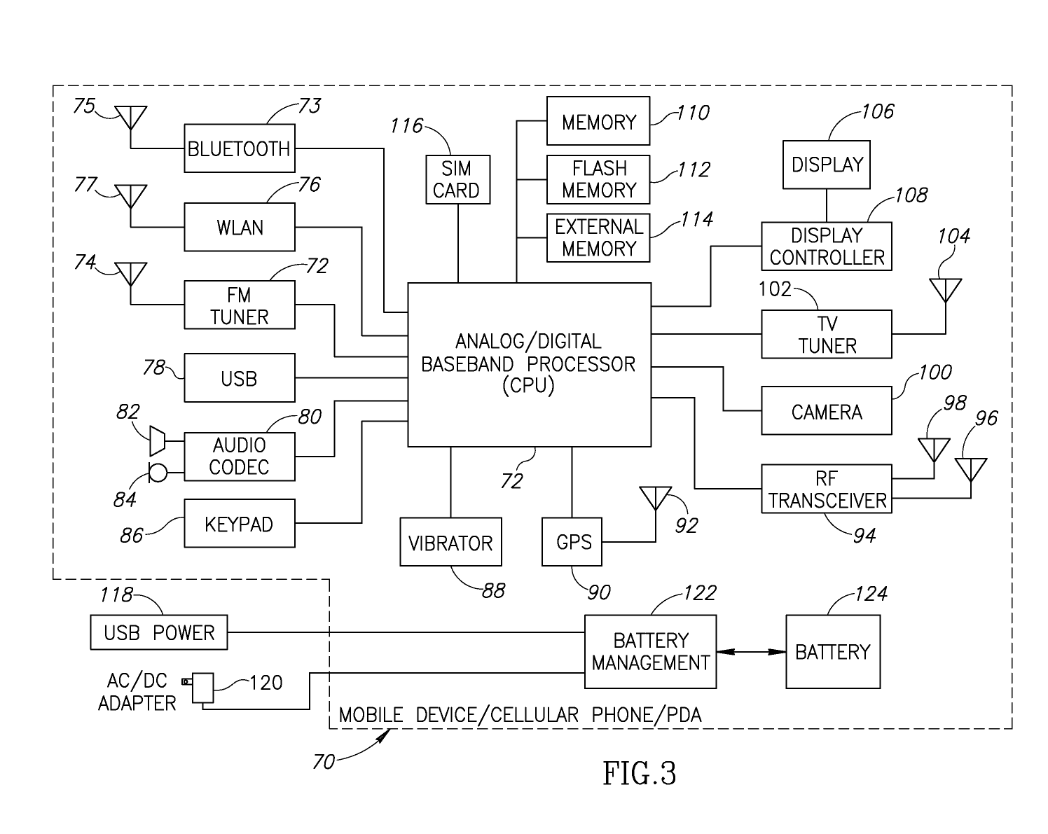

A block diagram illustrating an example mobile device/cellular phone/PDA system architecture suitable for use with the present invention is shown in FIG. 3. The mobile device/cellular phone/PDA (hereinafter the “cell phone”), generally referenced 70, comprises a baseband processor or CPU 72 having analog and digital portions. The basic cellular link is provided by the RF transceiver 94 and related one or more antennas 96, 98. A plurality of antennas is used to provide antenna diversity which yields improved radio performance. The cell phone also comprises internal RAM and ROM memory 110, Flash memory 112 and external memory 114.

Several user interface devices include microphone 84, speaker 82 and associated audio codec 80, a keypad for entering dialing digits 86, vibrator 88 for alerting a user, camera and related circuitry 100, a TV tuner 102 and associated antenna 104, display 106 and associated display controller 108 and GPS receiver and associated antenna 92.

A USB interface connection 78 provides a serial link to a user's PC or other device. An FM tuner 72 and antenna 74 provide the user the ability to listen to FM broadcasts. WLAN interface 76 and antenna 77 provide wireless connectivity when in a hot spot or within the range of an ad hoc, infrastructure or mesh based wireless network. Bluetooth interface 73 and antenna 75 provide Bluetooth wireless connectivity when within the range of a Bluetooth wireless network. SIM card 116 provides the interface to a user's SIM card for storing user data such as address book entries, etc.

Portable power is provided by the battery 124 coupled to battery management circuitry 122. External power is provided via USB power 118 or an AC/DC adapter 120 connected to the battery management circuitry which is operative to manage the charging and discharging of the battery 124.

### Secure Communications Server

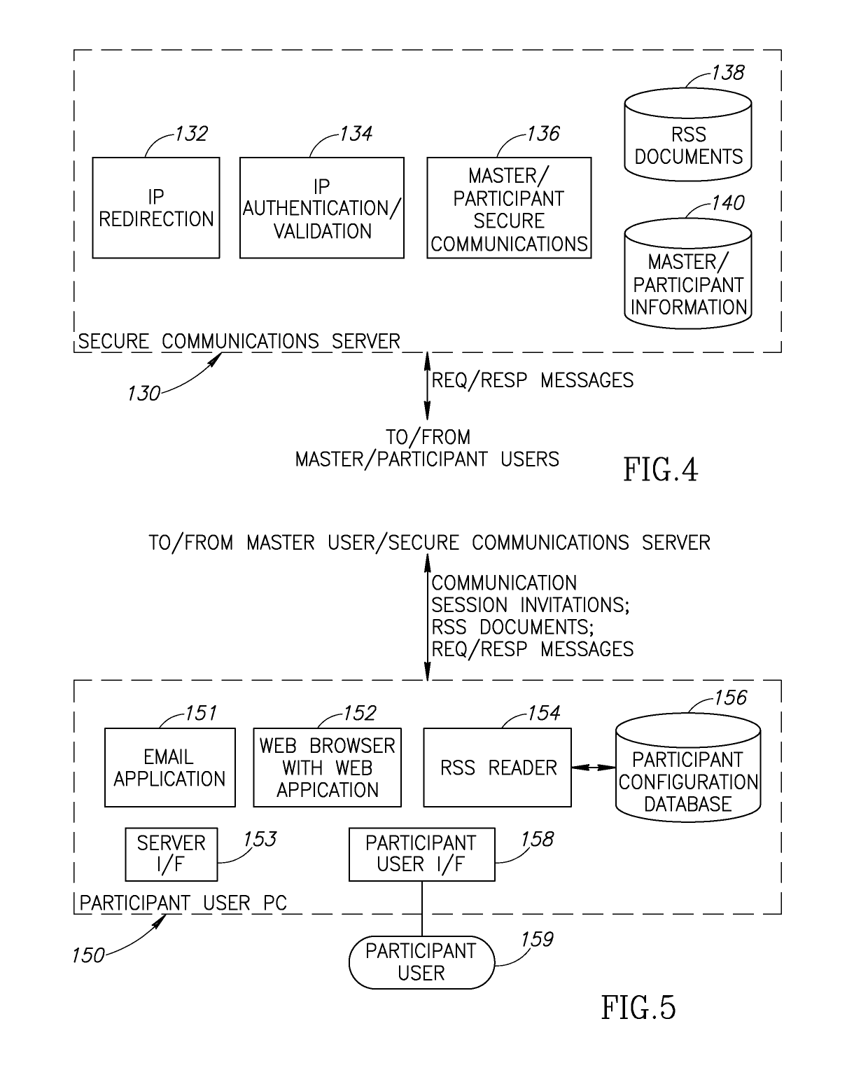

A block diagram illustrating the secure communications server of the present invention in more detail is shown in FIG. 4. The secure communications server, generally referenced 130, comprises an IP redirection module 132, IP authentication/validation module 134, master/participant secure communication module, RSS documents database 138 and master/participant information database 140. The secure communications service is optional and is not required for operation of the mechanism. If implemented and employed in the system, its purpose is to function as a “go-between” between the participant users enabling communications among them when the master user is off-line. The secure communications server may be located anywhere reside anywhere on the network (i.e. the Internet). The operation of the various components of the secure communications server will now be described in more detail.

In operation, participant user computers are configured to search for a secure communications server. This can be accomplished in similar fashion as configuring a POP email server within a conventional email client. To connect to the secure communications server, the participant user enters a domain name or IP address of the secure communications server. Once connected, an authentication and validation process is performed between the master user and the participant user (described in more detail infra). The difference in the case of the server is that the secure communications server functions as the go-between for the authentication and validation process. The master user does not need to be on-line for participant users to participate in a communications session.

The secure communications server represents the master user and the participant users using a UniqueID assigned to the master user and the participant users. Each UniqueID is used as a key for all records related to communication sessions between the master user and a participant user. Several items of information are stored in the master/participant information database 140 including but not limited to authentication key, WAN IP address, port numbers, usernames, passwords, PartnerIDs, MasterIDs, ParticipantIDs, etc. The RSS documents themselves are stored in the RSS document database 138. This scheme thus permits participant users to participate simultaneously in multiple communication sessions.

The secure communications server is adapted to communicate the UniqueID to the respective master user PC and participant user computers. The participant user computers then integrate the UniqueID into their RSS communication applications.

When a participant user desires to use the RSS based secure communications session, they communicate to the secure communications server using the UniqueID previously assigned to that particular participant user. The secure communications server utilizes that UniqueID to identify which RSS document files are available for that participant user. Once determined, the appropriate RSS document file(s) requested by the participant user via their associated RSS document reader application is served to the participant user.

In operation, master users via their secure communications application communicates (i.e. registers) its WAN IP address to the secure communications server before any exchange of messages occurs. The transfer of the IP address and related server information is encrypted at the master user PC before transmission utilizing a standard encryption methodology (e.g., public/private key, RSA, MD5, Blowfish, etc.) wherein the unique serial number of the secure communications server is used as the primary encryption key. The master user PC transmits this message to the secure communications server by way of HTTPS (SSL secured HTTP communication). The secure communications server listens for transmission traffic on a specific IP address and port number. When a master user PC attempts to deliver data to that IP address and/or port number, it first sends its serial number in a hash sequence to the secure communications server which decrypts the information to reveal the serial number. Note that only a secure communications server with the correct hash key can decrypt the unique serial number within the hash that was encrypted using the same key by the master user PC. Note also that the serial number can be generated through a random process and is provided to authorized participant users.

Once the serial number has been verified after being decrypted, the secure communications server creates a unique “connection key” that is transmitted to the master user. This key is then appended to each and every transmission between the master user PC and the secure communications server during the transaction of sending data from the master user PC to the secure communications server. Any communication that does not have a key appended to it will not be recognized by the secure communications server. The data from the master user PC is then sent in encrypted text to the secure communications server which decrypts the message from the master user PC and verifies it against a record in the master/participant information database using the MAC address as the primary key. If no record is found, a unique serial number is generated corresponding to the master user PC. A new record is created in the master/participant information database and the serial number along with the IP address, MAC address and port number of the master user PC are stored therein.

### Participant User Computer

A block diagram illustrating the participant user computer of the present invention in more detail is shown in FIG. 5. The participant user computer, generally referenced 150, comprises an email application 151, web browser with web application 152, secure communications server interface (I/F) module 153, server optional specialized RSS reader 154, participant configuration database 156 and participant user I/F 158. It is important to note that the participant user computer, in particular mobile participant user devices, may comprise any suitable computing device and is not limited to mobile or cellular devices. For example, the participant user computer can reside on cellular phones, mobile devices, PDAs, desktop PCs, laptop PCs, palmtop devices, or any other wired or wireless computing device. In accordance with the invention, it is not critical that the participant user computer comprise a unique software application. Alternatively, the participant user computer may comprise a conventional web browser that is capable of transmitting, receiving and rendering HTML and RSS documents.

The web browser (and specialized RSS reader) is a software application that runs on the mobile client for processing and displaying (i.e. rendering) RSS documents (e.g., RSS 2.0 documents) served by the master user via the network. It also provides connectivity to the master user and to the secure communications server. In the case of a conventional web browser a web application (provided by the master user PC or by any other source) provides basic functionality for working and interacting with RSS document based messages, such as searching, browsing, selecting, editing messages, creating new message threads, deleting threads, replying to messages, etc.

The same functionality can be provided in a specialized web application plug-in for a conventional standard web browser is installed and stays resident on the participant user's computer. Alternatively, a specialized RSS reader application can be used to provide the same functionality. In addition, the RSS reader can perform a portion of the authentication and validation functions that the master user PC would normally perform. In this embodiment, the participant configuration database is used to store participant related information that is used during authentication process and for regular exchanges of messages via RSS documents.

The participant user I/F provides a GUI to the participant user that enables a participant user to interact with RSS document based messages. Commands and data entered by the participant user are processed by the participant user I/F and forwarded to either the web browser or the RSS reader depending on the implementation.

The participant user computer also comprises a server I/F module 153 for configuring and maintaining RSS document based communications with the secure communications server. When multiple participant users wish to communicate with each other but the master user associated with the communications thread is no longer on-line, the server I/F module functions to setup the communications with the server. The serer I/F module is operative to search for a secure communications and once found to handle the authentication and validation process with the server.

### Master User PC

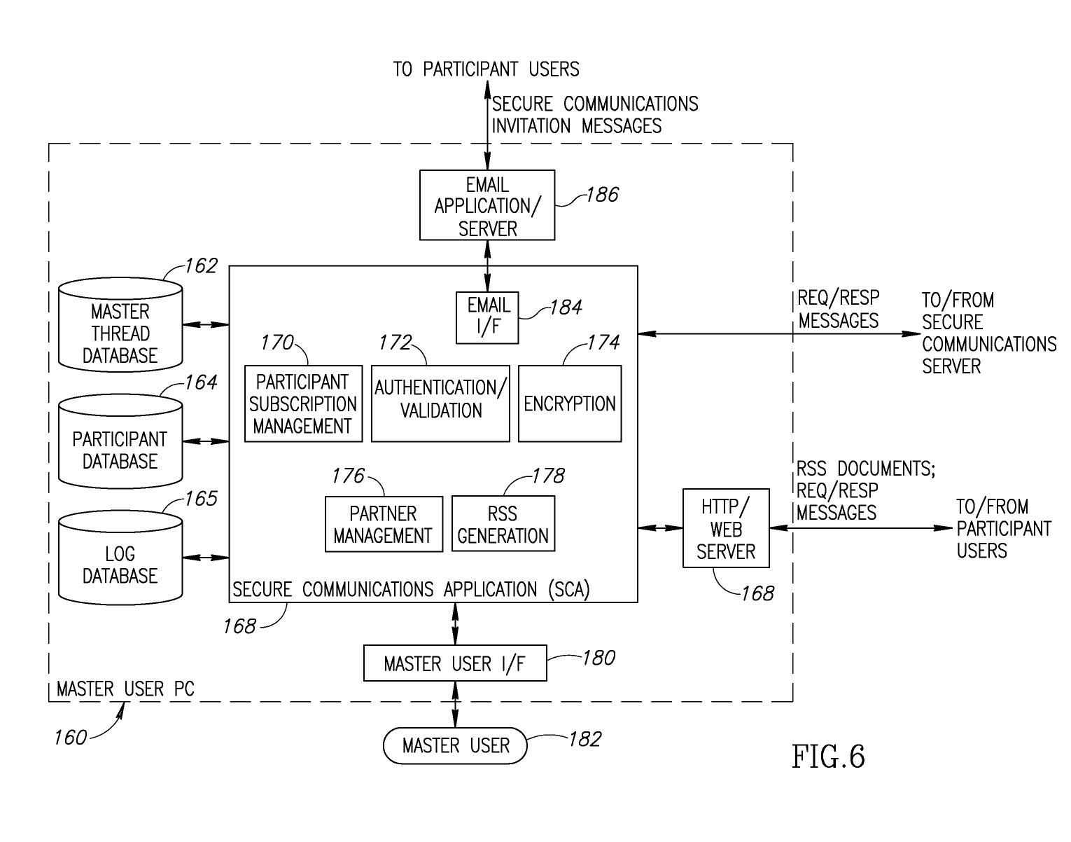

A block diagram illustrating the master user PC of the present invention in more detail is shown in FIG. 6. The master user PC, generally referenced 160, comprises a secure communications application (SCA) 168, master thread database 162, participant database 164, log database 165, email application/server 168, HTTP/web server 166 and master user interface (I/F) module 180. The SCA comprises a participant subscription management block 170, authentication/validation block 172, encryption block 174, partner management block 176, RSS generation block 178 and email interface 184. The RSS generator block is adapted to render files and resources in RSS format and to “translate” or “style” the RSS, a subset of XML, through eXtensible Style Sheet (XSTL) into HTML. The HTML is then consumed by any application capable of rendering HTML content, such as a conventional web browser or specialized RSS reader described supra. This mechanism allows “serialized content” such as RSS to be embedded into an otherwise normal looking webpage and not a list of RSS data elements. In the event that such rendering is handled by a specialized RSS reader, the RSS reader “consumes” the RSS data and renders it within its own GUI, without the need for “translation” or “stylization” as described herein.

The primary function of the secure communication application is to provide secure communication between the master user and one or more participant users. In accordance with the invention, the secure communications are provided via RSS documents that are exchanged between the master user and the participant users. A communications session (also referred to as a communications thread) is initiated utilizing conventional email application/server of both the master user and the participant users. Once a communications session is established, however, conventional email is not used. Rather, messages are communicated back and forth by reading the master RSS document and entering new messages (either through a web-based form or a specialized RSS application) which are then updated to the participant user RSS document and copied to the master RSS document and subsequently presented to all participant users within the communication thread.

On ingress, the SCA is operative to receive messages (replies, new threads, etc. referred to herein as “communication events”) in RSS format from the several participant users. In accordance with the invention, the SCA is operative to store communication events from each of the participant users in a separate participant user RSS document, stored in the participant database 164, and dedicated only to that particular participant user. The content of the communications event is also copied to a master communications thread RSS document stored in the master thread database 162. On egress, however, the SCA is operative to only serve the master communications thread RSS document to the participant users. The participant user RSS documents are never served to the participant users.

The subscription manager functions to (1) manage the various unique IDs assigned to the participant users (ParticipantID) who are subscribed to RSS document feeds; (2) manage the files associated with those unique IDs; and to interface with the master thread database, participant database and log database and the master user PC's operating system file structure.

The RSS generator is adapted to handle all the activities associated with the physical RSS documents (i.e. master communications thread RSS document, etc.) including but not limited to creating, deleting and modifying (adding to it and removing from it) RSS documents. The HTTP web server is operative to provide the participant users access to the RSS document feeds through a conventional Internet web browser or other RSS-enabled clients as well as other standard, web-application functionality that allows participants to read and enter messages.

The authentication and validation block is operative to handle the initial authentication and validation of each participant user invited to join a communications thread. It also provides initial authentication and validation of remote access to an RSS resource. The encryption block is adapted to handle the generation of encryption keys for the authentication and validation block as well as the continuous encryption/decryption of RSS documents once the communication thread is set up and established.

The partner manager block is adapted to manage all interactions with participant users that are subscribed to RSS feeds as “partners”, such as trading partners in an Electronic Data Interchange (EDI) system.

The SCA has access to the master user PC hard disk contents (not shown) and can also interface with one or more applications (e.g., email server 186, IM gateway, SMS gateway, etc.).

As described supra, the SCA comprises three databases: a master thread database 162, a participant database 164 and a log database 165.

The master thread database 162 is adapted to store records related to each new communications thread created. Records in the master thread database are created by the SCA each time a new communications thread is to be created. The master thread database comprises the following fields:
a) MasterID: a randomly generated, unique ID used to identify this particular communications thread from other threads. The MasterID is generated by the SCA and refers to the communication thread created by the master user as the “originator.” The MasterID is also used to create the master communications thread RSS document wherein the MasterID represents the document name as a physical file on the hard drive;
b) Date: the date the communications thread was created;
c) Time: the time the communications thread was created;
d) DocName: the name assigned to the master communications thread RSS document that embodies the communications thread;
e) RSSDoc: a pointer to or the location of the master RSS document on the user's hard drive or other memory device;

The participant database is adapted to store records for each participant user associated with a communications thread. A new record is created for each participant user. The participant database comprises the following fields:
a) MasterID: the MasterID from the master thread database (used as the relational link to the master thread database);
b) ParticipantID: a unique ID representing the participant user for the particular communications thread (the ParticipantID is randomly generated by the SCA);
c) EncryptionKey: the encryption key associated with the particular participant user;
d) Name: the name of the participant user;
e) Email: the email address of the participant;
f) Date: the date the participant user was added to the participant database;
g) Time: the time the participant user was added to the participant database;
h) DocName: the name of the RSS document associated with the particular participant user;
i) RSSDoc: a pointer to or the location of the master RSS document on the user's hard drive or other memory device;
   Note that the Name and Email fields are optional as they can be regenerated using the EncryptionKey. In some cases, it may be desirable to omit these two fields from the participant database to reduce the security risk in the event of a breach or hacking into of the master user PC.

The log database is adapted to track every attempted communication into either the master thread database or the participant database. This database comprises the following fields:
a) IP address: the IP source address from which the request originated;
b) Data: the date the request was made;
c) Time: the time the request was made;
d) Success/Failure: Boolean value indicating either success or failure of the authentication process;

### Establishing a New Communications Session

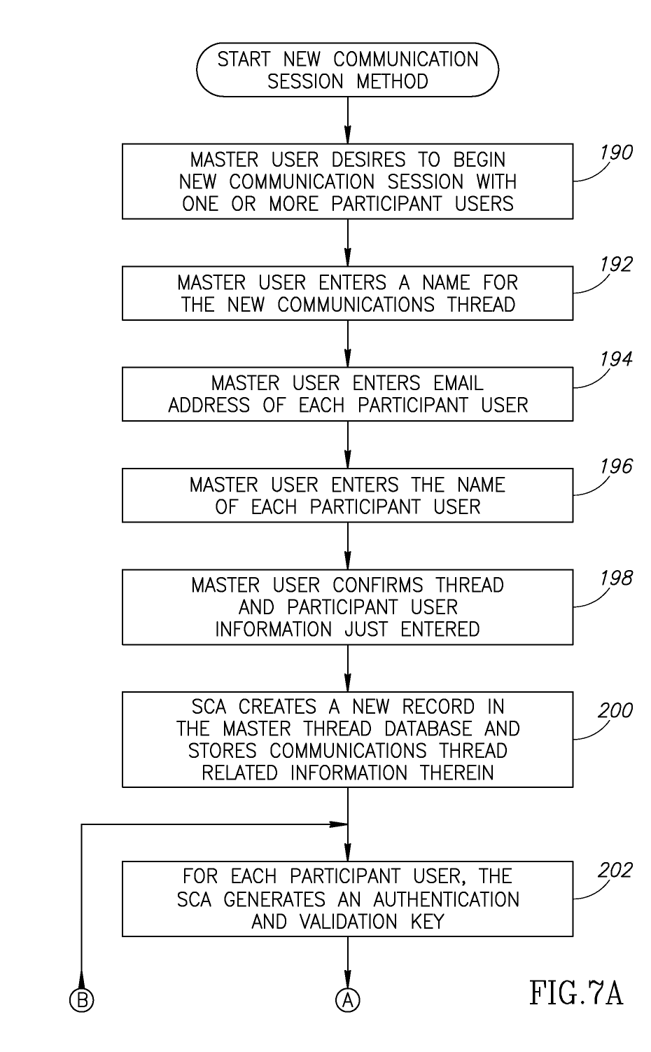

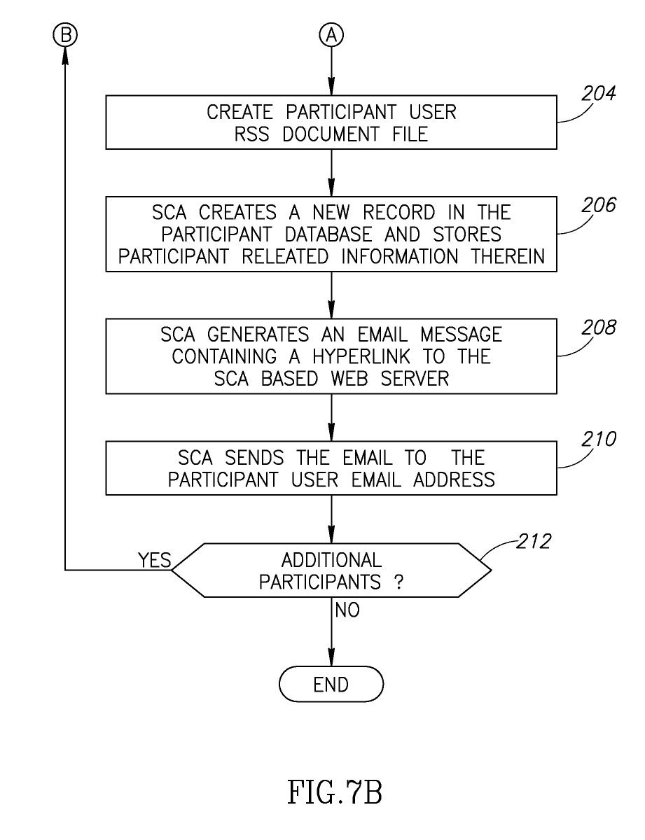

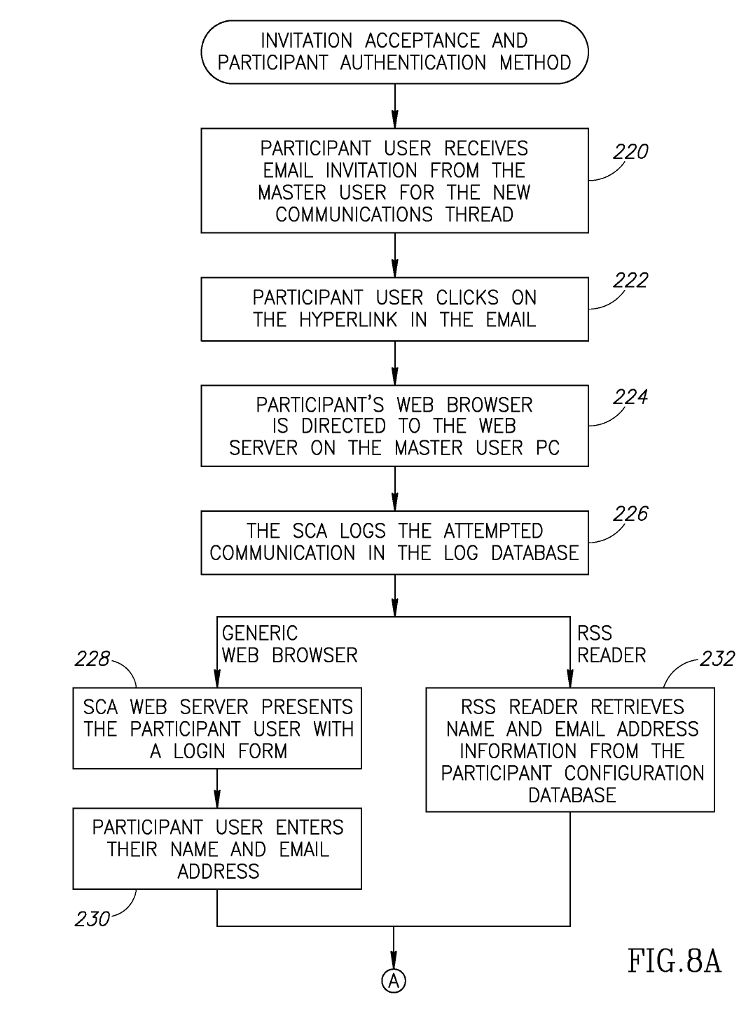

Flow diagrams illustrating the method of starting a new communications session are shown in FIGS. 7A and 7B. With reference to FIGS. 4, 5 and 6, the following provides a description of the processing sequence for establishing a new communications thread between the master user and one or more participant users. This method is performed by the SCA in the master user PC.

The master user first indicates that they wish to start a new communication thread with one or more participant users (step 190). This indication could originate through an existing PIM application into which the secure communications mechanism is integrated, from a stand-alone application or through a web service wherein the secure communications application is actually run on a server in communication with the master user PC. Regardless of the actual implementation of the invention, the master user supplies several items of information to establish the new communications thread.

The master user enters a name for the new communications thread (step 192). Since the mechanism of the invention is based on RSS documents, the name can be anything but would most likely be the first and last name or email address of the master user, which could be configured via the invention to be entered automatically. Next, the master user enters the email address of at least one participant user (step 194). Note that the entry of participant user email address is a recursive process, allowing the master user to enter multiple email addresses if there are a plurality of participant users to be invited to join the communications thread. Next, the master user enters the name of each participant user (step 196). Note that in an alternative embodiment, the names and email addresses of the participant users can be obtained from a contact database record (e.g., a V-Card in Microsoft Outlook) rather than be entered manually.

Next, the SCA presents a recap screen to the master user for confirmation of the thread and participant user information just entered (step 198). Once the data entries are confirmed, several database records are created as described below. First, the SCA creates a new record in the master thread database and stores communication thread related information therein, including the MasterID to identify the communication thread, DocName to identify the master communication thread RSS file, the data/time (step 200) and master communications thread RSS document.

For each participant user entered, the invention generates an authentication and validation key (step 202). The authentication and validation key is generated using a standard encryption algorithm by encrypting the name and email address of the participant user using a key such as the unique serial number of the invention and then combining the two encrypted text items together. This single, large encryption key is then used to name the participant user RSS document file. In addition, this encryption key is also used to identify communication events received from different participant users when participant user RSS documents from multiple participant users within a single communication thread are synchronized.

The method also creates the physical participant user RSS document file (step 204). The name of the participant user RSS document file comprises a concatenation of the MasterID (i.e. name of the communication thread) and the encryption key.

The SCA then creates a new record in the participant database and stores participant related information therein, including the MasterID, ParticipantID, EncryptionKey and participant user RSS document (step 206).

For each participant user identified as taking part in a communication thread, the SCA generates an email invitation containing a hyperlink to the SCA based web server (step 208). The SCA then sends the email message invitation having a destination of the email address of the participant user (step 210). The email invitation can be sent using any suitable means such as by accessing the API of the email application/server on the master user PC. The email invitation is typically received by a conventional email client running on the participant user computer. When received, the participant user clicks on the link and is connected to the web server integrated in the master user PC. A different hyperlink is generated and inserted in each email message. If there are additional participant users to send invitations to (step 212), the method returns to step 202. Otherwise, the method terminates.

In an alternate embodiment, a specialized RSS reader application designed to facilitate secure communication via RSS could provide a participant user the ability to “subscribe” to a communication thread. In this case, the participant user enters the URL contained in the email invitation received from the master user into the RSS reader application which then sends the HTTP request to the SCA integrated web server in the master user PC.

In this manner, the authentication process (described in detail infra) is carried out “behind the scenes” by the specialized RSS reader in the participant user computer. The RSS reader is operative to pass to the SCA for processing the email address of the participant user that was previously stored in the participant configuration database 156 (FIG. 5). The SCA, in response, returns to the RSS reader in a reply message the ParticipantID referring to that particular participant user.

In response, the RSS reader stores this information in a record within its local participant configuration database that includes the following fields:
a) MasterID: a unique ID identifying the communication thread;
b) IP address: the IP address of the SCA web server for the communication thread;
c) ParticipantID: the ID of the participant user within that communication thread;

Note that the invention utilizes the really simple syndication (RSS) format to send document and email related information between the SCA and the mobile device. Every object that can be identified through a Uniform Resource Identifier (URI) or Uniform Resource Locator (URL) is a resource that can be embedded in an RSS document. An RSS document contains information about which information objects are to be found under a URI or URL. In addition, it can include a description of the resource and the individual information objects, the specification of a unique identifier for the objects and other information. It is also possible that the information object described may be completely embedded in the feed document.

All RSS documents are translated into serialized strings of characters and they use existing formats for content, i.e. simple text, HTML, XHTML, other XML vocabularies. RSS works independently of the internal structure of the information. Any item or collection of information can be the object of a RSS document. There are two kinds of information objects in all RSS formats, that is, collections of new information items and new individual items of information. The collections are called a channel (or a feed); an object within a collection is called an item or an entry. Both the channel and the item comprise content information, metadata, and information about the identification and linking of information objects.

An RSS document may describe another web resource, namely, the resource that is identified by the content of the link element. The presence of an element called a link, and with it, the ability to identify a document it refers to, distinguishes RSS documents from other web formats like HTML. The link element only states what the RSS document describes.

One of the characteristics of RSS is that the description is defined very generically making it is possible to include any type of content in the description. Thus, any kind of web content can be sampled and further distributed in an RSS document.

In addition, RSS, as a subset of XML, can be “translated” and “stylized” through eXtensible Style Sheet (XSTL) into HTML and thereby consumed by any application capable of rendering HTML content, such as a conventional web browser. This mechanism allows “serialized content” such as RSS to be embedded into an otherwise normal looking webpage and not a list of RSS data elements.

### Invitation Acceptance and Participant Authentication Method

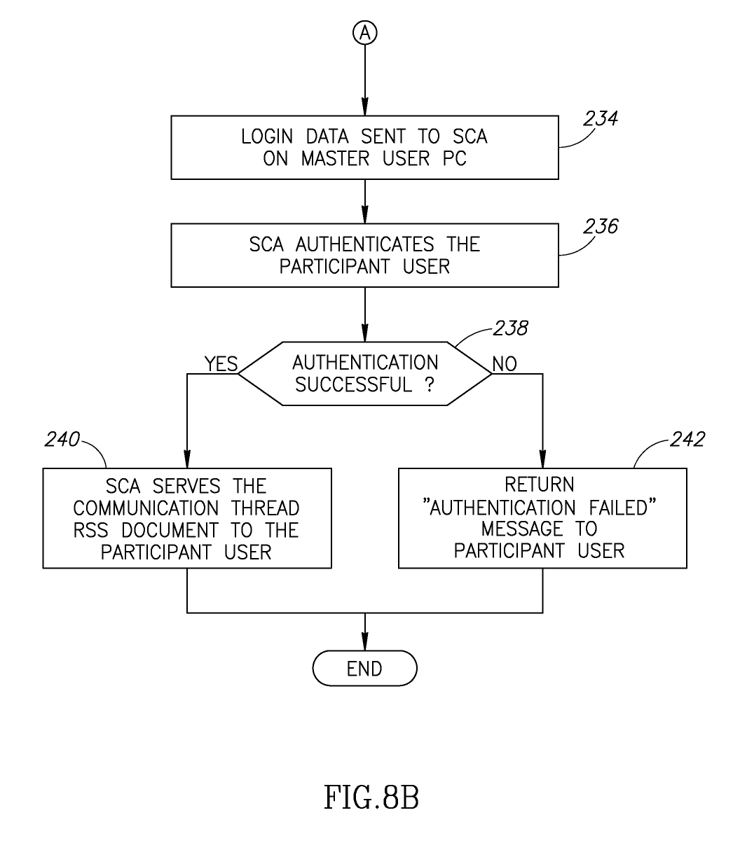

Flow diagrams illustrating the invitation acceptance and participant authentication method of the present invention is shown in FIGS. 8A and 8B. The following describes the authentication process carried out by the secure communications mechanism of the present invention when a participant user connects to (i.e. joins) a communication thread to which she/he was invited.

First, the participant user receives the email invitation from the master user for the new communications thread (step 220). The participant user opens the email using any standard email application and clicks on the hyperlink sent in the email invitation (step 222). Note that the hyperlink comprises a URL that includes the IP address and port number of the master user PC which hosts the SCA. When the participant user clicks on the hyperlink, the participant user's internet browser is directed to the web server integrated with the SCA on the master user PC (step 224).

At the master user PC, the first SCA logs the attempted communication into the log database 165 (FIG. 6) (step 226). The next steps depend on whether the participant user is using a conventional web browser or a specialized RSS reader. The following assumes the participant user is using a conventional web browser. The SCA web server presents the participant user with a login form for entry of their name and email address (step 228). The URL of the SCA web server on the master user PC is known and the participant user does not need to be queried for it. The participant user then enters their name and email address (step 230).

In the case of a specialized RSS reader, the RSS reader automatically retrieves the name and email address information for the participant user from the participant configuration database 156 (FIG. 5).

Once the name and email address are entered, the user clicks submit and the login data is sent to the SCA on the master user PC (step 234). The SCA receives the login credential data through the web server and authenticates the participant user (step 236). The authentication process encrypts the participant name and email address and compares the name, email address and resultant encrypted string to the records stored in the participant database 164 (FIG. 6). If authentication is successful (step 238), the SCA presents the master communication thread RSS document to the participant user (step 240). Note that the master communication thread RSS document represents an aggregation of all communication events received from all the participant users. If authentication failed, the SCA returns an “authentication failed” message to the participant user (step 242).

### Interaction with the Communication Thread

The secure communication mechanism of the present invention provides a capability for participant users to easily reply and add to communication threads. This can be accomplished in one of two ways depending on whether the participant computer implements a standard web browser or the specialized RSS reader.

In the case of a standard Internet browser, a web application is provided by the HTTP web server of the invention that implements the methods of the present invention. In particular, the web application is operative to facilitate the reading, responding to, printing, etc. of communication threads through standard web technologies (e.g., HTML forms, processing languages such as ASP, PHP, .NET, Java, scripting languages such as Javascript, etc.). It is appreciated that the look and feel of the web application preferably is similar to existing web-based email readers such as HotMail, Yahoo!Mail or Google Mail. Using the web browser, the participant user can read individual messages, respond to messages, create new messages, etc.

It is important to note that each link in any of the pages presented to the user comprises an encrypted value appended to the URL. For example, if the user clicks the button for a “new message”, the URL might be
“newmessage.php?ID=349fdkkj3h89f3jadf9&SESSION=kjdf983875kdjf”
   where the value after the ID is the encrypted version of the ParticipantID that identifies the participant user and the SESSION is the unique SessionID created by the HTTP web server of the invention and assigned to the connection session between the participant user's computing device and the master user's computer. In this manner, the SCA at the master user PC can determine from whom the action carried out (e.g., communication event) is from and can append a message to the appropriate participant user RSS document file.

In the event that a malicious user intercepted communications from the participant user, that malicious user would have the encrypted ParticipantID. Unfortunately, without knowledge of the serial number of the invention (i.e. SCA) used to encrypt the ParticipantID, that data would be useless and could not be used to “penetrate” or “spoof” the communication thread.

Furthermore, if the malicious user then attempted to utilize the ParticipantID to interact with the communication thread (e.g., insert false messages, modify existing messages, etc.) as the participant user, they would be unable to do so as the HTTP web server of the master user PC requires the SessionID value to be supplied in order to authenticate communication. Note that the SessionID is generated by the SCA web server and forwarded to the client upon successful authentication of the participant user to the master user's computer as described supra. The malicious user would need to gain access to the participant user's computer after authentication had occurred.

In the case of a specialized RSS reader, when a participant user subscribes to an RSS feed through a specialized RSS reader, the RSS reader stores the ParticipantID in its configuration database. Note that the ParticipantID is generated by the master user and transmitted to the participant upon successful authentication. This ParticipantID is then sent via HTTP (or other suitable means) to the SCA web server of the master user PC along with the SessionID. The SCA web browser, receiving communication events from all participant users, parses the ParticipantID from the communication event and utilizes it to properly place all communication events received from a specialized RSS reader on one of the participant user computers into the appropriate participant user RSS document file in the participant database 164 (FIG. 6). The SessionID is, as described previously, generated upon successful authentication by the invention and is unique to each communication session between each participant user computing device (whether RSS reader or browser) and the master user's computer.

Note that to facilitate determining the source of communication events, the SCA on the master user PC generates a unique ID (i.e. a “cookie”) that the participant user uses in communications to the master user. Note also that this cookie is not the same as the encryption key. This is analogous to the SessionID used to distinguish one web browser session from another.

### Aggregation of Individual Participant Communication Threads

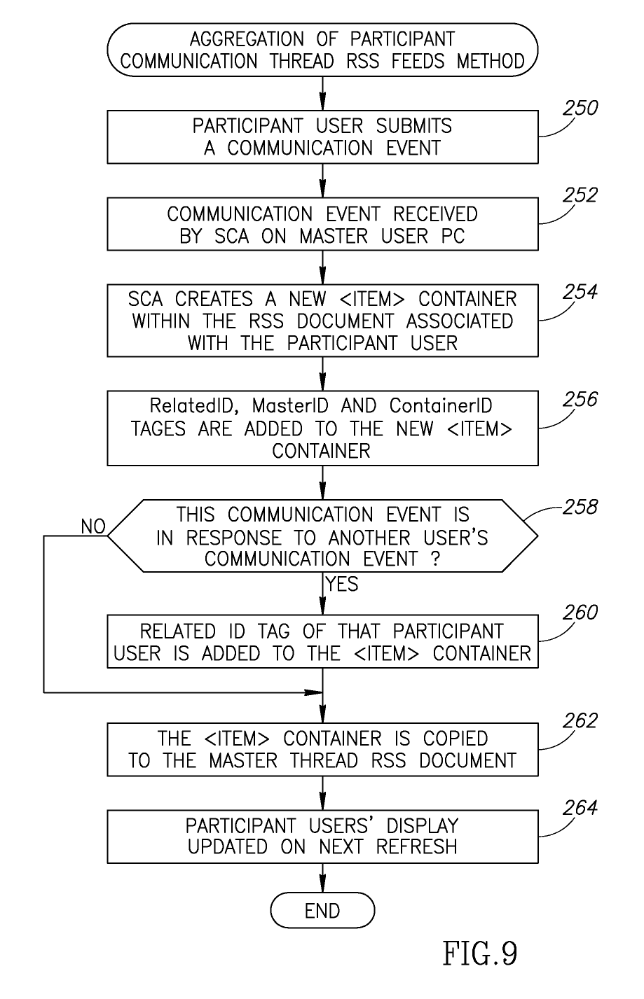

A flow diagram illustrating the participant communication thread RSS feeds aggregation method of the present invention is shown in FIG. 9. As described supra, the present invention provides for a synchronized presentation of all communication event messages from the master user and all participant users. This is achieved by aggregating the message elements from all individual threads, wherein an individual thread is defined as the communication events between one of the participant users and the master user.

The benefit of aggregating communication events from all users is by subscribing only to the master communications thread, participant users can view the entire communications thread without the need to receive all the individual communication threads of the other participant users. In addition, by all participant user communication threads separate, searches against individual participant users can be quickly carried out by searching a specific participant user RSS document feed without the need to search the entire master communication thread RSS document feed.

Aggregation of individual participant user communication threads is carried out as follows. First, participant send communication events to the master user in an asynchronous manner (step 250). The communication event is received by the SCA on the master user PC (step 252). The SCA creates a new <Item> container within the participant user RSS document associated with the particular participant user that sent the communication thread (step 254).

Each <Item> container within a participant user RSS document feed includes the unique ParticipantID. Thus, rather than store the communications event as an “<Item>,” the method of the invention represents each event as “<Item #34398349#%12312312%$96059$>” where the numerical value between the pound signs (#) is the ParticipantID, the numerical value between the percent signs (%) is the MasterID and the numerical value between the dollar signs ($) is the ContainerID of the <item> container within the participant user RSS document file.

The pound, percent and dollar signs are used to provide a simpler method to facilitate parsing of the data. Alternatively, additional tags could be added to the <Item> container as follows (step 256).
a. <ParticipantID>34398349</ParticipantID>
b. <MasterID>12312312</MasterID>
c. <ContainerID>15.96059</ContainerID> (Note that this is a concatenation of the ParticipantID, using the period as the delimiter and a uniquely generated ID specifically for this <Item>)

When a participant user submits a communication event (i.e. a new message, reply, etc.) either through an internet browser (after being successfully authenticated) or through a specialized RSS reader, the SCA creates a new <Item> container within the RSS document corresponding to the participant user. If the communication event is a response to another participant user's communication event (step 258), the ParticipantID of that participant user is also added to the <Item> container as follows (step 260).
a. <RelatedCommunicationEvent>RelatedID#</>

Once the new <Item> container has been created, the SCA method then copies that <Item> container to the master communication thread RSS document (step 262). Note that this RSS document is the RSS document to which all participant users subscribe to. In accordance with the invention, the participant user RSS documents are never served to participant users as they are intended only as containers for received participant user communication events. The actual process of communicating messages through the thread is carried out using the master communication thread RSS document. Note that the master communication thread RSS document is refreshed on the participant users' web browser when initiated by the participant users (by clicking “refresh” button) or on the RSS reader when configured to periodically poll for updated master RSS documents on the master user PC (step 264).

In an example implementation of the invention, the following represents a proposed RSS schema for participant user RSS documents.
<Item>
<RelatedID>
<MasterID>
<ContainerID>
<RelatedCommunicationEvent>
<title>Subject of communication</title> {in the event that this is a response to a previous event, the title would automatically be appended with “RE:”}
<description>The subject of the message</description>
<enclosure/>any attachments</enclosure> {attachments would be uploaded, as a process through the invention's web server, to the computer where the RSS documents are stored; this would be a URI pointer to the file on the hard drive system}
<Item>

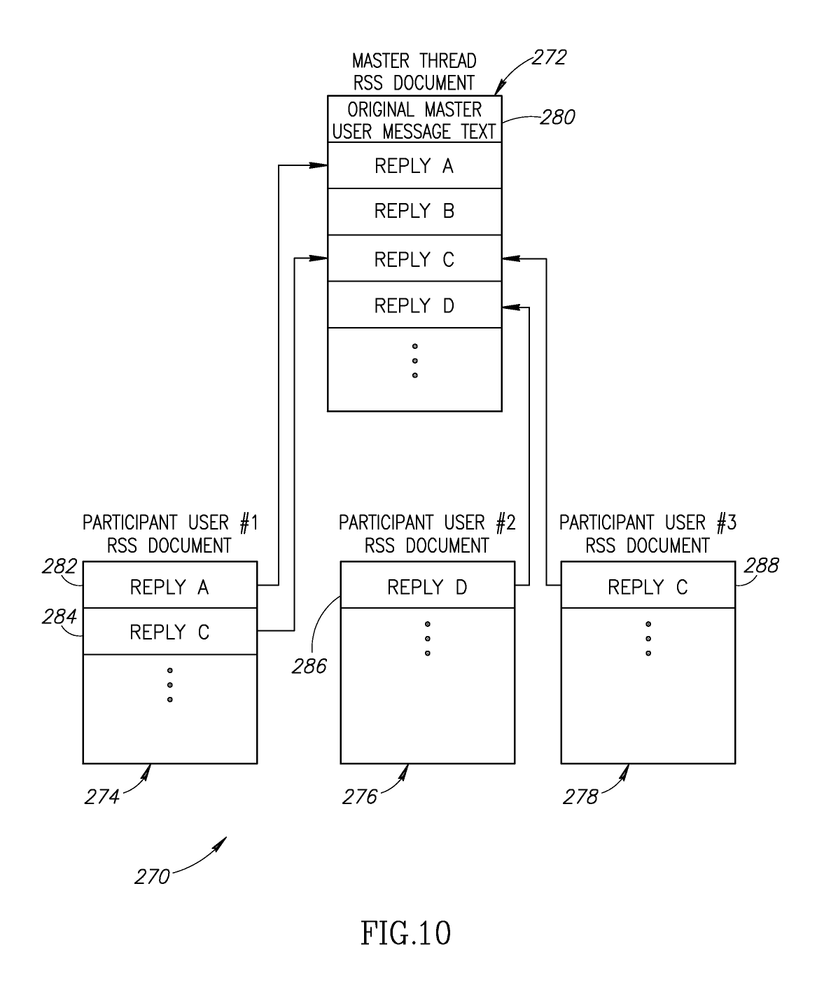

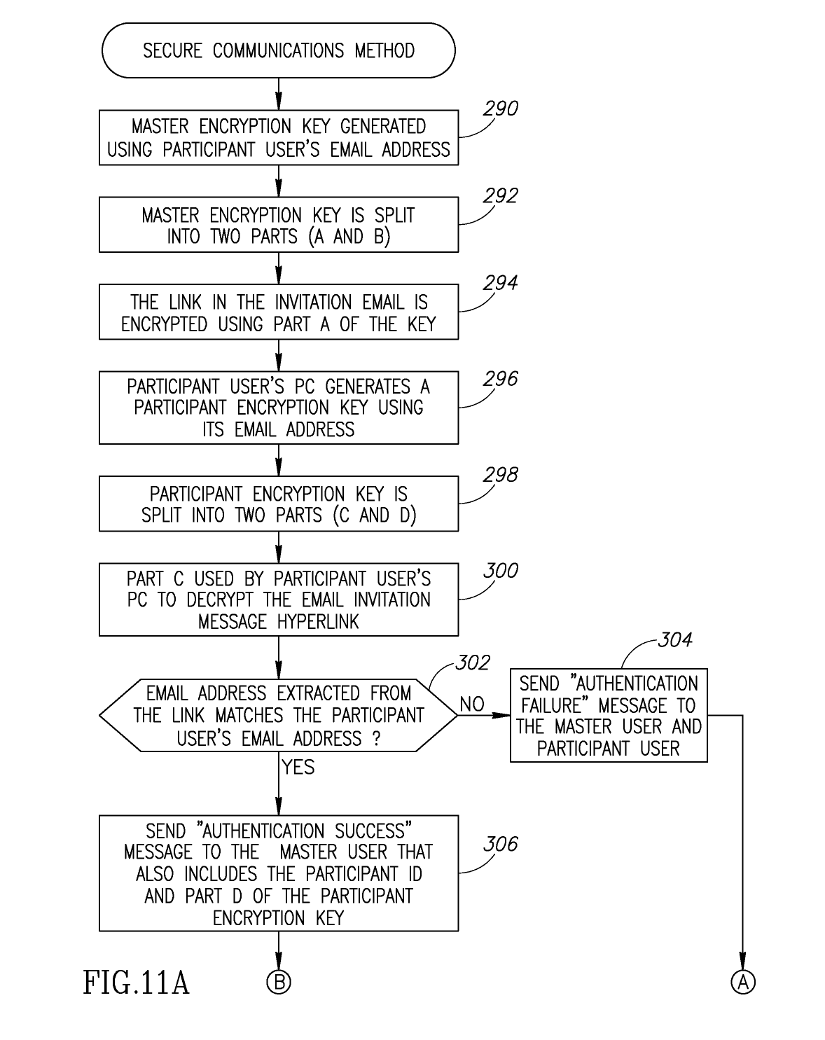

A diagram illustrating an example application of the participant communication thread RSS feeds aggregation method of FIG. 9 is shown in FIG. 10. In this example, generally referenced 270, the RSS documents 274, 276, 278 for three participant users #1, #2, #3, respectively, are shown comprising reply messages (<Item> containers were stored in each). Each is uniquely labeled reply A 282, B 284, C 288 and D 286 for illustration purposes only. In accordance with the methods of the present invention, after the communication events are stored in the participant user RSS documents, they are copied t the original master thread document in order of receipt. The master thread RSS document thus comprises the original master user message text 280 followed by replies A, B, C and D. It is this master RSS document that is then served to the participant users and not the individual participant user RSS documents.

### Secure Communications Method

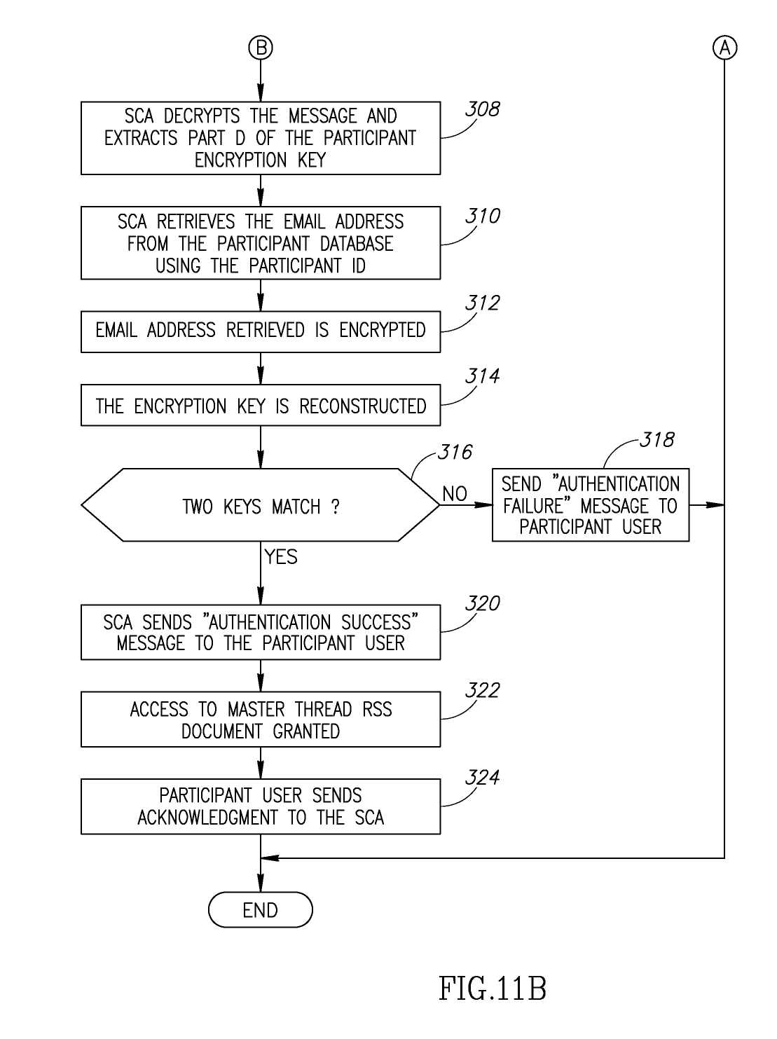

Flow diagrams illustrating the secure communications method of the present invention is shown in FIGS. 11A and 11B. The following describes an example method of creating a secure communication stream between the master user and one or more participant users. As described supra, a communication thread is created by entering several pieces of information. An important piece of information is the email address to which the email invitation will be sent. The email address is used to generate a 128-bit master encryption key (in this example) using a standard algorithm (e.g., MD5, Blowfish, public/private key encryption, etc.) (step 290).

Once the master encryption key is generated, it is split into two parts A and B (step 292). Part A of the master encryption key is used to encrypt the hyperlink in the email invitation that the participant ultimately clicks on (step 294). The information in the hyperlink comprises the IP address of the master user PC, the port number, unique MasterID, unique ParticipantID and the email address to which the email invitation is being sent.

Once the email invitation is received, the participant user computer generates a participant encryption key using the email address of the participant user (step 296). As on the master user PC, the participant encryption key is split into two parts C and D (step 298). Once the participant encryption key has been split, the participant user computer uses part C to decrypt the email invitation message link (step 300). The email address extracted from the link is compared to the participant user's email address (step 302). If a match is not found, an “authentication failure” message is sent to the master user and the participant user (step 304).

If the email address removed from the email invitation message link matches the participant user's email address, then authentication is positive and an “authentication success” message is sent to the master user that also includes the ParticipantID and part D of the participant encryption key (step 306). The SCA then decrypts the message and extracts part D of the participant encryption key (step 308). The SCA retrieves the email address attached to the record in the participant database using the ParticipantID (step 310). The email address retrieved is encrypted (step 312). The encryption key is then reconstructed (step 314) from the part A of the master encryption key and the part D of the participant encryption key in the message. The two keys are compared (step 316), and if they match the SCA sends an “authentication success” message to the participant user (step 320). Otherwise, the SCA sends an “authentication failure” message to the participant user (step 318). Once authenticated, access to the master thread RSS document is granted (step 322). The participant user sends an acknowledgment to the SCA (step 324).

Note that once the authentication and validation process has completed successfully, the key used during that process is also used to encrypt and decrypt the actual RSS text in the communication thread. Note also that the key is also used for all further communications between the master user and the participant user.

### Send Message Method

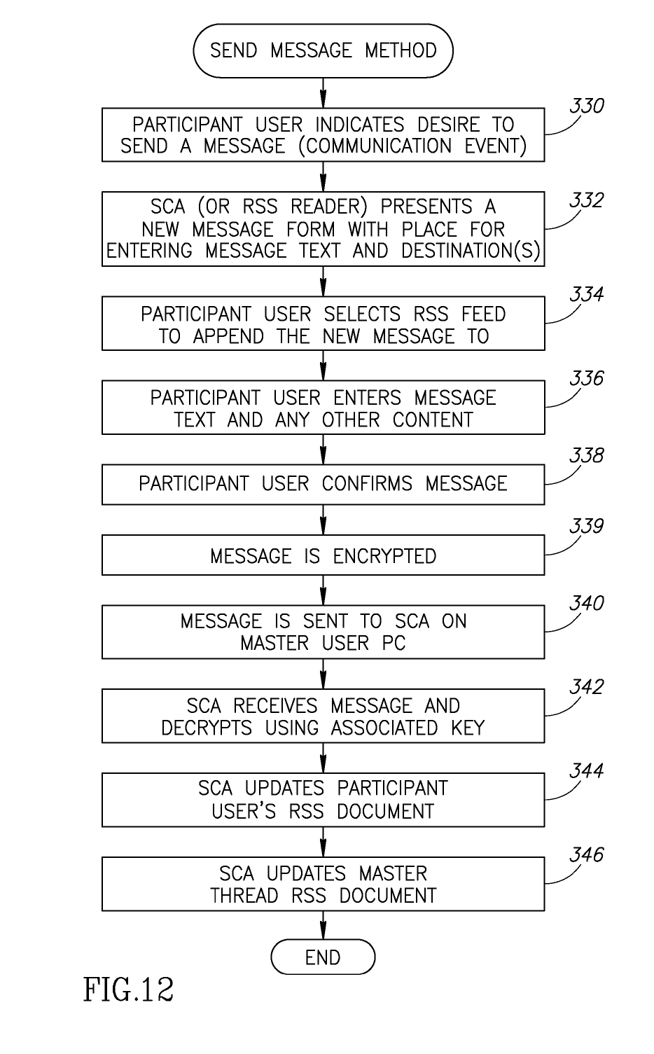

A flow diagram illustrating the send message method of the present invention is shown in FIG. 12. The following describes the basic process through which a participant user can send a message to another participant user by updating their individual participant user RSS document feed for the secure communication session.

First, the user indicates they wish to send a message (i.e. communication event) to another participant user (step 330). This can be accomplished by, for example, clicking on a button for a new message, etc. In response, the SCA (or RSS reader) serves up a new message form with a place for entering message test and destinations (i.e. participant user email addresses) (step 332). The “new message form” presented allows a participant user to specify to whom to send the message and to enter the message text. The user selects the participant user RSS document feed they want to append the new message to (step 334). This may be done through a drop-down or an additional pop-up window and is similar to selecting an email recipient from a list of contacts. Note that this step is typically not necessary as identification of the participant user is all that is required to determined which participant user RSS document to append messages to.

The participant user then enters the text of the message, attaches files, etc. (step 336). The participant user can also employ at this time a spelling or grammar check is desired. Finally, the participant user confirms the message (step 338). The message is encrypted using the key associated with that participant user (step 339) and the message is sent to the SCA on the master user PC (step 340). The SCA receives the message and decrypts the message using the associated key specific to that communication session and that participant user (step 342). The SCA then updates the participant user's RSS document file (step 344). The SCA then updates the master thread RSS document which is subsequently served to the participant users for display (step 346).

### Example GUI Implementation

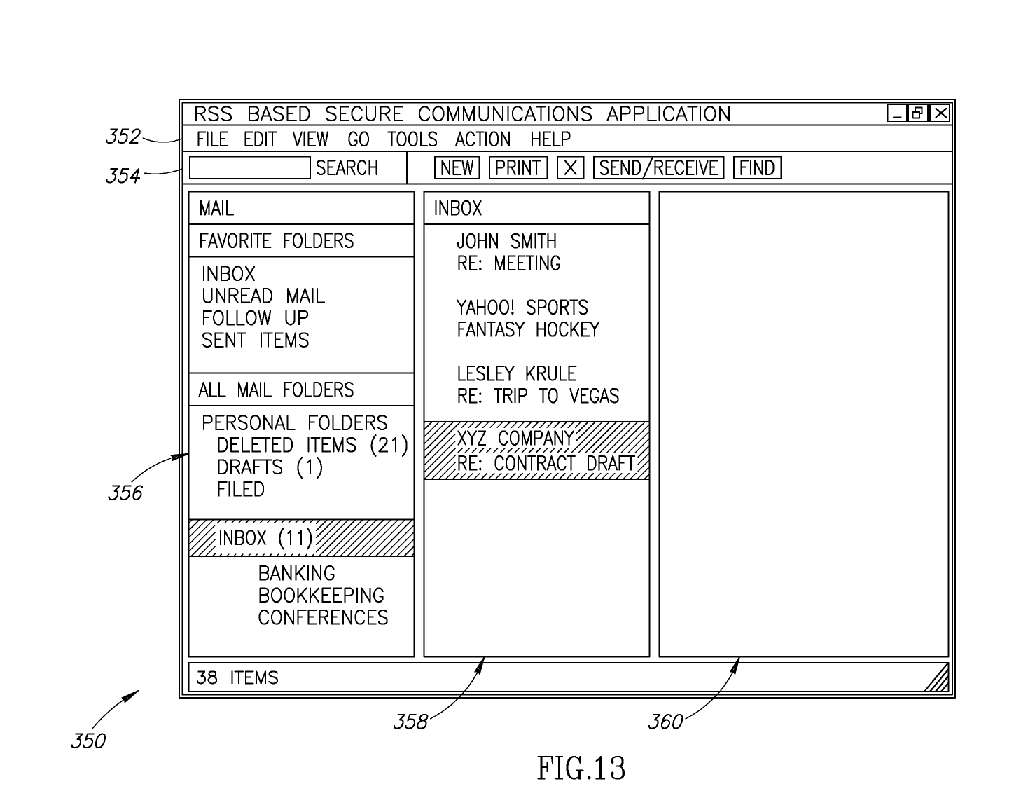

An example GUI screen shot of an example implementation of the RSS based secure communications application of the present invention is shown in FIG. 13. The sample screen shot, generally referenced 350, illustrates an example of how a participant may interact with the secure communications application through a graphical user interface (GUI). Via the GUI, the participant user has the ability to interact with specific participant user RSS document files as provided by the secure communication mechanism of the invention.

The main features of the display comprise a drop down menu bar 352, search box and tool bar icons 354, a section 356 for displaying the RSS files stored either locally or on the master user PC, a section 358 for displaying the items/elements within an RSS document and a section 360 for displaying the rendered contents of the highlighted RSS document.

In operation, a participant user opens the GUI application which is operative to display a list of all available RSS documents that represent secure communication sessions. These RSS documents can either be stored locally or rendered from a server using the MasterID of the master user. When a participant user clicks on an RSS document, the <Item> tags are rendered as individual “communications” between users. The participant user can then click on an <Item> to display the full RSS content in the right section in similar fashion to a standard email application.

In alternative embodiments, the methods of the present invention may be applicable to implementations of the invention in integrated circuits, field programmable gate arrays (FPGAs), chip sets or application specific integrated circuits (ASICs), DSP circuits, wired or wireless implementations and other communication system products.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. A method of secure communications between a master user and one or more participant users, said method comprising the steps of:
generating an authentication key for each participant user;
sending an email invitation from said master user to each said participant user, said email invitation incorporating a hyperlink encrypted using a participant user's authentication key corresponding thereto;
authenticating one or more participant users;
serving a master communications thread really simple syndication (RSS) document to each successfully authenticated participant user;
storing communication events received from participant users in separate participant user RSS documents; and
aggregating the contents of all participant user RSS documents into said master communications thread RSS document.

2. The method according to claim 1, wherein said step of generating comprises encrypting a combination of participant user name and corresponding email address.

3. The method according to claim 1, wherein said hyperlink comprises a uniform resource locator (URL) of said master user.

4. The method according to claim 1, wherein said step of authenticating comprises the step of logging each communication attempt made by said participant users.

5. The method according to claim 1, wherein said step of authenticating comprises the steps of:
encrypting the participant name and email address to generate a second authentication key; and
comparing said second authentication key with said previously generated authentication key and declaring authentication success if a match is found.

6. The method according to claim 1, wherein said step of storing comprises the step of adding to a received communication event a ParticipantID tag adapted to identify a particular participant user and a MasterID adapted to identify a communication session.

7. The method according to claim 1, wherein said step of storing comprises the step of adding to said communication event a RelatedCommunicationEvent tag if said communication event is a response to a second participant user's communication event, said RelatedCommunicationEvent adapted to identify said participant user.

8. The method according to claim 1, further comprising the step of providing to said participant users a capability of creating a new communication event and editing or deleting an existing communication event.

9. A computer program product, comprising:
a computer usable medium having computer usable program code for secure communications between a master user and one or more participant users, said computer program product including;
computer usable program code for generating an authentication key for each participant user;
computer usable program code for sending an email invitation from said master user to each said participant user, said email invitation incorporating a hyperlink encrypted using a participant user's authentication key corresponding thereto;
computer usable program code for authenticating one or more participant users;
computer usable program code for serving a master communications thread really simple syndication (RSS) document to each successfully authenticated participant user;
computer usable program code for storing communication events received from participant users in separate participant user RSS documents; and
computer usable program code for aggregating the contents of all participant user RSS documents into said master communications thread RSS document.

10. An apparatus for secure communications between a master user and one or more participant users via one or more communication networks, comprising:
a master thread database adapted to store one or more master communication thread really simple syndication (RSS) documents and information related thereto;
a participant database adapted to store one or more participant user RSS documents and information related thereto;
an encryption unit adapted to generate an authentication key for each participant user and to encrypt and decrypt RSS document communications between said master user and said one or more participant users;
a participant subscription management unit operative to send an email invitation to each participant user, said email invitation incorporating a hyperlink encrypted using a participant user's authentication key corresponding thereto;
an authentication unit operative to authenticating one or more participant users;
an RSS document generator comprising:
means for storing communication events received from successfully authenticated participant users in separate participant user RSS documents; and
means for aggregating the contents of all participant user RSS documents associated with a communications session into a single master communications thread RSS document.

11. The apparatus according to claim 12, further comprising a log database for recording each communication attempted by said participant users.

12. The apparatus according to claim 12, wherein said encryption unit is operative to generate said authentication key by encrypting a combination comprising a name of a participant user and an email address corresponding thereto.

13. The apparatus according to claim 12, wherein said hyperlink comprises a uniform resource locator (URL) of said master user.

14. The apparatus according to claim 12, wherein said authentication unit comprises means for logging each communication attempt made by said participant users.

15. The apparatus according to claim 12, wherein said authentication unit comprises:
means for encrypting a participant's name and email address to generate a second authentication key; and
means for comparing said second authentication key with said previously generated authentication key and declaring authentication success if a match is found.

16. The apparatus according to claim 12, wherein said RSS document generator comprises means for adding to a received communication event a ParticipantID tag adapted to identify a particular participant user and a MasterID adapted to identify a communication session.

17. The apparatus according to claim 12, wherein said RSS document generator comprises means for adding to said communication event a RelatedCommunicationEvent tag if said communication event is a response to a second participant user's communication event, said RelatedCommunicationEvent adapted to identify said participant user.

18. The apparatus according to claim 12, wherein RSS document generator comprises means for means for providing a participant user the capability of creating a new communication event and editing or deleting an existing communication event.

19. A method of secure communications between a master user and one or more participant users via one or more communication networks, said method comprising the steps of:
receiving an email invitation from a master user to join a communications session;
replying to said email invitation with participant user login credentials; and if the participant user login authentication was successful,
sending communication event messages to said master user whereby said communication event messages are appended to a separate participant user really simple syndication (RSS) document; and
displaying to said participant user a master communications thread RSS document received from said master user that represents an aggregation of all participant user RSS documents.

20. A computer program product, comprising:
a computer usable medium having computer usable program code for secure communications between a master user and one or more participant users via one or more communication networks, said computer program product including;
computer usable program code for receiving an email invitation from a master user to join a communications session;
computer usable program code for replying to said email invitation with participant user login credentials; and if the participant user login authentication was successful,
computer usable program code for sending communication event messages to said master user whereby said communication event messages are appended to a separate participant user really simple syndication (RSS) document; and
computer usable program code for displaying to said participant user a master communications thread RSS document received from said master user that represents an aggregation of all participant user RSS documents.

21. A method of secure communications between a master user and one or more participant users, said method comprising the steps of:
sending an email invitation from said master user to each said participant user requesting participation in a communications session;
authenticating one or more participant users utilizing login credentials provided by each respective participant user;
receiving communication events from one or more participant users and storing all communication events associated with each participant user in a separate participant user really simple syndication (RSS) document; and
copying said communication event into a master communication thread RSS document for serving to all said participant users.

22. The method according to claim 21, wherein said step of storing comprises the step of adding to a received communication event a ParticipantID tag adapted to identify a particular participant user and a MasterID adapted to identify a communication session.

23. The method according to claim 21, wherein said step of storing comprises the step of adding to said communication event a RelatedCommunicationEvent tag if said communication event is a response to a second participant user's communication event, said RelatedCommunicationEvent adapted to identify said participant user.

24. The method according to claim 21, wherein said step of sending comprises the step of generating an authentication key for each participant user and using said authentication key to encrypt a hyperlink sent in said email invitation.

25. The method according to claim 21, wherein said step of authenticating comprises the step of serving said master communications thread RSS document to each successfully authenticated participant user.

26. The method according to claim 21, wherein said step of storing comprises the step of creating a new >Item> container in a corresponding participant user RSS document and storing said communication event therein.

27. The method according to claim 21, wherein said step of copying comprises the step of copying an <Item> container in said participant user RSS document for storing said communication event to said master communication thread RSS document.
